(19) United States
(12) Patent Application Publication
(10) Pub. No.: US 2009/0071153 A1
(43) Pub. Date: Mar. 19, 2009

(54) METHOD AND SYSTEM FOR ENERGY STORAGE AND RECOVERY

(75) Inventors: Chenna Krishna Rao Boyapati, Bangalore (IN); Chellappa Balan, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/199,320

(22) Filed: Aug. 27, 2008

Related U.S. Application Data
(60) Provisional application No. 60/972,475, filed on Sep. 14, 2007.

(51) Int. Cl. F03G 4/00; F02G 1/043; F03C 1/00; F02G 1/057

(52) U.S. Cl. 60/641.2; 60/517; 60/526; 60/531

(57) ABSTRACT

Disclosed herein is a system for generating energy, comprising a first heat exchanger in communication with a first heat source; wherein the first heat exchanger contacts a transfer fluid that comprises a working fluid and an associating composition; and a first energy conversion device comprising a piston in reciprocatory communication with a cylinder; the cylinder comprising an inlet or an outlet valve in operative communication with a cam having multiple lobes; the cam permitting the expansion or compression of the working fluid in the cylinder two or more times in a single cycle.

### RELATED APPLICATIONS

This application is a non-provisional application that claims priority to provisional U.S. Pat. application Ser. No. 60/972475, filed Sep. 14, 2007; the disclosure of which is hereby incorporated by reference.

### BACKGROUND

1. Technical Field

The invention includes embodiments that relate to a system for thermochemical heat energy storage and recovery. The invention includes embodiments that relate to a method for energy storage and recovery.

2. Discussion of Art

Some fuel energy is wasted in the form of exhaust and dissipated heat in, for example, a power plant or in the operation an engine. Some engines may be on vehicles with dynamic brake resistors. This dissipated energy is generally not recovered. It may be desirable to recapture some of the energy lost in the exhaust of the engine as well as the energy that is dissipated.

It may be desirable to have a method that differs from those methods currently available. It may be desirable to have a system to generate energy with properties and characteristics that differ from those of currently available systems

### BRIEF DESCRIPTION

In one embodiment, a system is provided that includes a first heat exchanger in communication with a first heat source. The first heat exchanger may contact a transfer fluid that includes a working fluid and an associating composition. The system may also include a first energy conversion device that includes a piston in reciprocatory communication with a cylinder. The cylinder includes a valve that may be in operative communication with a cam having multiple lobes. The cam may permit the expansion or compression of the working fluid in the cylinder two or more times in a single cycle.

In one embodiment, system for generating energy is provided that includes a first heat exchanger in communication with a first heat source. The first heat exchanger heats a transfer fluid that includes a working fluid and an associating composition. The working fluid and the associating composition reversibly associate with each other. The heating of the transfer fluid in the first heat exchanger may generate a vapor comprising the working fluid. A first separator may be in the communication with the first heat exchanger and downstream of the first heat exchanger. A first superheater communicates with the first separator and is downstream of the first heat exchanger. A first energy conversion device includes a piston in reciprocatory communication with a cylinder. The cylinder includes a valve in operative communication with a cam having multiple lobes. The cam may cause or permit the expansion or compression of the working fluid in the cylinder two or more times in a single cycle. The system further includes an absorber downstream of the first energy conversion device, and which may be in communication with the energy conversion device. The absorber receives the vapor that has passed through the energy conversion device and receives the associating composition that has passed through the heat exchanger. A first regenerator may be located upstream of the absorber and may be in communication with the absorber. The regenerator may receive the transfer fluid from the absorber and may allow the transfer fluid to return to the first heat exchanger. The system includes a pump in communication with the first heat exchanger.

In one embodiment, a method is provided that includes dissociating a transfer fluid. The transfer fluid includes a working fluid and an associating composition. A vapor of the working fluid is produced. The vapor contacts a moving surface of an energy conversion device with the vapor of the working fluid to effect an energy conversion. The energy conversion device includes a piston in reciprocatory communication with a cylinder; where the cylinder includes an inlet or an outlet valve in operative communication with a cam having multiple lobes. The cam may permit the expansion or compression of the working fluid in the cylinder two or more times in a single cycle.

### BRIEF DESCRIPTION OF DRAWINGS

FIG. 1 is an exemplary depiction of one embodiment of a method for generating energy from heat extracted from another source.

FIG. 2(a) is a graphical representation of a P—V diagram for a 2-stroke engine.

FIG. 2(b) is an exemplary depiction of the a 2-stroke reciprocating engine during the downward stroke of the piston.

FIG. 2(c) is an exemplary depiction of the a 2-stroke reciprocating engine during the expansion of the working fluid.

FIG. 2(d) is an exemplary depiction of the a 2-stroke reciprocating engine during the upward stroke of the piston.

FIG. 3(a) is an exemplary depiction of a two lobed cam that is used to permit the entry of the working fluid into the 2-stroke reciprocating engine.

FIG. 3(b) is an exemplary depiction of a two lobed cam that is used to permit the exit of the working fluid into the 2-stroke reciprocating engine.

FIG. 4 is another exemplary depiction of one embodiment of a method for generating energy using a continuous process.

FIG. 5 is a schematic depiction of one exemplary embodiment of a single stage system 10 for generating energy.

FIG. 6 is an exemplary depiction of one embodiment for using the system 10 as an energy storage device.

FIG. 7 is a schematic depiction of one exemplary embodiment of a system that can be utilized to convert energy from the braking systems of locomotives into electrical energy.

FIG. 8 is a schematic depiction of one exemplary embodiment of a multistage system 10 for generating energy.

FIG. 9 is a schematic depiction of one exemplary embodiment of a multistage system 10 for generating energy.

### DETAILED DESCRIPTION

The invention includes embodiments that relate to a system for thermochemical heat energy storage and recovery. The invention includes embodiments that relate to a method for using an energy storage and recovery device.

In one embodiment, systems and methods are provided for generating energy from sources of heat that are normally lost, such as, for example, the exhaust streams of engines, vehicle braking systems, including those used on diesel engine locomotives; chemical and nuclear reactors; and any other application or device where energy is lost in the form of heat. The engines can include internal combustion engines and turbine engines.

As used herein, communication refers to fluid and thermal communication, unless context or language indicates the type of communication used. “Thermal communication” refers to communication that involves the transfer of heat. Such communication may involve radiation, conduction, convection, or a combination thereof. “Fluid communication” refers to communication that involves the transfer of a fluid. In some embodiments, fluid communication may involve thermal communication (e.g., the transfer of a fluid from one point to another, where both points are not at the same temperature) or may not involve thermal communication (e.g., the transfer of a fluid from one point to another, where both points are at the same temperature). Thermal communication may involve fluid communication (e.g., convection or conduction) or may not involve fluid communication (e.g., radiation).

In one embodiment, systems and methods for generating energy from heat sources is provided. These heat sources may include geothermal or solar heat energy sources. This conversion of lost energy into useful energy may improve the efficiency of the system. Such a modification may reduce emissions. Additionally, the wasted heat may be stored for a period of time and may be used during periods of low energy supply or during periods when the demand for energy is high.

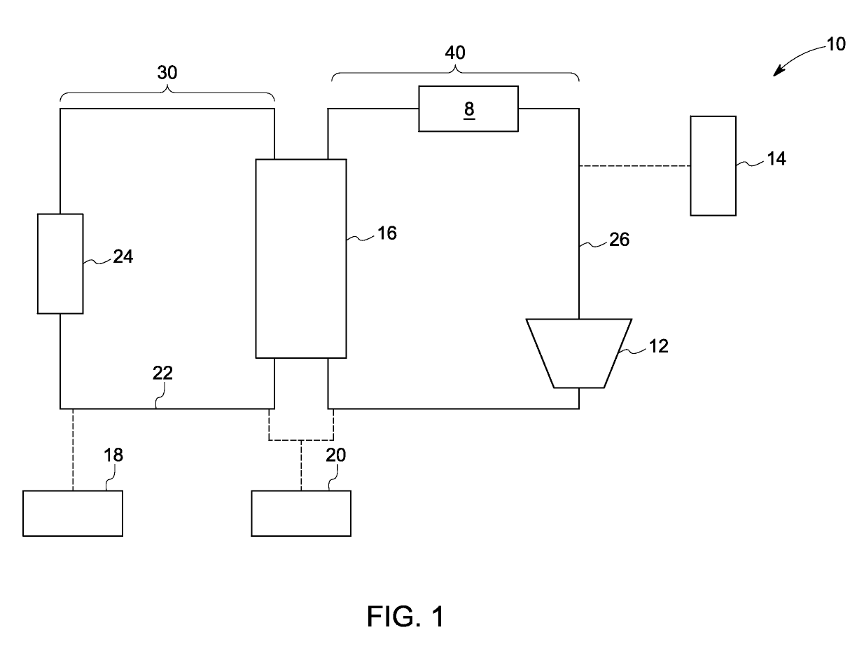

With reference to FIG. 1, an exemplary embodiment of a system 10 for generating energy comprises an energy conversion device 12, a first absorber 8 and a first heat exchanger 16. The system 10 may also have optional components such as, for example, a cooling station 14, a make-up fluid reservoir 18, and a central monitoring station 20. Other optional components may be included in the system 10, depending upon the nature of the particular application for which the system 10 may be being designed. Examples of such optional components include but are not limited to a superheater, a separator, an intercooler and a regenerator. The functions of the superheater, the separator, the intercooler and the regenerator are detailed hereinbelow. If present, a first pipe 22 may be used to transfer energy in the form of heat from a heat source 24.

In one embodiment, a first fluid in the first pipe 22 transfers heat from the heat source 24 to the first heat exchanger 16. The first pipe 22 may therefore form a heat supply system 30, which may be in the form of a closed loop and includes the heat source 24 and the first heat exchanger 16. In another embodiment, the first pipe 22 may facilitate the supply of heat to the first heat exchanger 16, without the use of a closed loop 30. In this event, the first fluid in the first pipe 22 may be exhausted to the environment or to a waste stream after transferring its heat to the first heat exchanger 16.

In one embodiment, the first heat exchanger 16 may be located downstream of the heat source 24. In one embodiment, the heat supply system 30 includes the following elements—the heat source 24, the first heat exchanger 16, and the first pipe 22. The first heat exchanger 16 may also be in fluid and/or thermal communication with a first absorber 8 and a first energy conversion device 12 via a second pipe 26 that may form a closed loop 40. The closed loop 40 includes the following elements—the first heat exchanger 16, a first absorber 8, the first energy conversion device 12 and the second pipe 26. In one embodiment, a transfer fluid contacts the first heat exchanger 16, the first absorber 8 and the first energy conversion device 12 via the second pipe 26. In the closed loop 40, the first energy conversion device 12 may be located down stream of the first heat exchanger 16 and may be in fluid and/or thermal communication with the first heat exchanger 16. In one embodiment, the first absorber 8 may be located downstream of the energy conversion device 12 and may be in thermal and/or fluid communication with it. The first absorber 8 may also incorporate a cooling station if desired. In one embodiment, the heat supply system 30 and the closed loop 40 may be in thermal and/or fluid communication with one another via the first heat exchanger 16. Optional elements that may be present in the heat supply system 30 and the closed loop 40 are valves, nozzles, pumps, cooling towers, monitoring and control stations, make up fluid tanks, or other devices that may be used in power generation plants and equipment. These are not shown in the FIG. 1.

In one embodiment, when a monitoring station is used, it may be in electrical communication with the elements of the heat supply system 30, the closed loop 40 as well as any other loops or devices that may be used in the system 10. The monitoring station may employ a host of communication devices such as computers and other forms of electronic control to communicate with and control the elements of the heat supply system 30 and the closed loop 40.

In one embodiment, when the first pipe 22 facilitates the supply of heat to the first heat exchanger 16 without the use of a closed loop 30, the first fluid may include a hot exhaust. Examples of suitable hot exhaust streams are those emitted from an internal combustion engine such as a diesel or gasoline engine. In one embodiment, the first fluid may also be the exhaust emitted from the exhaust stream of a chemical reactor or processing equipment. Another example is the heat rejected from a nuclear reactor. Other suitable examples of a first fluid that may be transferred in the first pipe 22 to the first heat exchanger 16 are exhaust from sources such as, for example, braking system of automobiles or locomotives, gas or steam turbine exhaust, incinerators, cement kilns, oxidation processes for ammonia and others, furnaces such as, for example, copper reverberatory furnaces, forge and billet-heating furnaces, annealing furnaces, open-hearth steel furnaces, basic oxygen furnaces, sulfur ore processors, glass melting furnaces, zinc fuming furnaces, or the like, or a combination comprising at least one of the foregoing sources.

In another embodiment, the first fluid may be recycled between the heat source 24 and the first heat exchanger 16. In such cases, the first pipe 22 forms a closed loop 30 and may be in thermal and/or fluid communication with the heat source 24.

In one embodiment, when the heat source 24 includes the earth, the first fluid, which may include water, may be supplied through a deep well drilled to access a heat source of the earth's crust, often at a depth of about 1,500 to about 3,000 meters below the earth's surface. The area includes porous rock, which is referred to as “dry rock,” and does not interfere with water aquifers. This porous, and often fractured, rock, when combined with the water introduced via the well, may form a porous heat exchanger with the dispersed heat transfer area, sometimes covering several cubic kilometers. Another well may be drilled in the fractured rock and behaves as a return well. The first fluid that is pumped down to the hot rock via the supply well may be heated by contacting the hot rock, following which it may be drawn through the return well to the ground level to be fed to the first heat exchanger 16. In another embodiment, steam from below the earth's surface may be directly used in the first heat exchanger 16 to heat the transfer fluid. This may be referred to as “wet geothermal” and may not need pumping fluid into the ground.

In one embodiment, when the heat source 24 is the sun, solar radiation may be collected via solar panels or other solar radiation collectors that may be in thermal and/or fluid communication with the first heat exchanger 16. The term thermal and/or fluid communication as described herein indicates that the communication may be thermal communication, fluid communication or a combination of thermal and fluid communication. Thermal communication permits the direct heating of the transfer fluid in the first heat exchanger 16 and may optionally obviate the use of the first fluid. In another embodiment, relating to the use of the sun as a heat source 24, solar energy may be permitted to impinge on hollow panels that contain the first fluid. The first fluid may be heated in the panels and this heat may be subsequently transferred to the first heat exchanger 16 when the heated first fluid flows to first heat exchanger 16.

As stated above, the heat supply system 30, in some embodiments, includes a first pipe 22 in thermal and/or fluid communication with the first heat exchanger 16 and the heat source 24. The first fluid may flow from the heat source 24 to the first heat exchanger 16 through the pipe 22. In certain embodiments, the first fluid may be heated by the heat source 24 to a temperature of greater than or equal to about 100° C. In another embodiment, the first fluid may be heated to a temperature of greater than or equal to about 500° C. The first fluid may transfer its heat to the transfer fluid in the first heat exchanger 16. In some embodiments, after transferring its heat to the transfer fluid in the first heat exchanger 16, the first fluid may be pumped back to the heat source 24 in the first pipe 22. Alternatively, as noted above, the first fluid may be alternatively exhausted into a waste stream or to the environment.

The first fluid that flows through the pipes 22 may be any fluid or fluidized media that may be capable of absorbing heat rapidly from the heat source 24. The first fluid may include a fluidized solid, a liquid or a gas. As noted above, the first fluid may be the gaseous exhaust from an internal combustion engine, a chemical reactor, a nuclear reactor, or the like. In one embodiment, when the heat supply system 30 may be in the form of a closed loop, the first fluid may be a liquid that may be recycled. The liquid may include monomers, oligomers or polymers. Examples of suitable liquids that may be used as the first fluid are water and other aprotic polar solvents; alcohols, ketones, and other polar protic solvents; benzene, toluene, and other non-polar solvents, and combinations comprising at least one of any of these liquids.

In one embodiment, the first fluid may also comprise oligomeric fluids. Suitable examples of such fluids include but are not limited to polyethylene glycol, polypropylene glycol, polytetramethylene ether, or the like, or a combination comprising at least one of the foregoing fluids. Ionic liquids, which mainly include the imidazolium salts, may also be utilized for as the first fluid. The first fluid may also include electrolytes. Electrolytes may consist of a liquid and a salt. The first fluid may also include additives such as anti-corrosive additives, self-sealing agents to fix ruptures in the first pipe 22, viscosity modifying agents, thermal stabilizers, or the like, or a combination comprising at least one of the foregoing additives. An exemplary first fluid may be water.

In one embodiment, the first heat exchanger 16 may be used for facilitating a heat transfer between the first fluid and the transfer fluid. Examples of suitable heat exchangers include shell and tube heat exchangers, plate type heat exchangers such as spiral plate exchangers, plate and frame exchangers, brazed plate fin heat exchanger, plate, fin and tube surface heat exchanger, bayonet tube exchangers, spiral tube exchangers, rotating shell heat exchangers, or the like. In one embodiment, the heat exchanger may have a heat transfer efficiency of greater than or equal to about 70%. In another embodiment, the heat exchanger may have a heat transfer efficiency of greater than or equal to about 80%. In another embodiment, the heat exchanger may have a heat transfer efficiency in a range of about 70% to about 75%; from about 75% to about 80%; from about 80% to about 85%; from about 85% to about 95%; or greater than or equal to about 95%.

In one embodiment, the second pipe 26 may facilitate the movement of the transfer fluid between the first heat exchanger 16, the first energy conversion device 12. In another embodiment, where an absorber may be used, the second pipe 26 may facilitate the movement of the transfer fluid between the first heat exchanger 16, the first energy conversion device 12 and, the first absorber 8. The transfer fluid may include an associating composition and a working fluid. The working fluid may be capable of a thermally reversible association and dissociation with the associating composition. The association between the working fluid and the associating composition may include absorption, adsorption, chemisorption, physisorption, formation of ionic bonds, covalent bonds, ligands, or the like, or a combination comprising at least one of the foregoing. The association may be exothermic and the heat generated during the association may be removed from the transfer fluid. In one embodiment, the dissociation may include desorption, the breaking of bonds formed during chemisorption such as the breaking of ionic bonds, covalent bonds, ligands, hydrogen bonds, overcoming of Van der Waals forces, or the like, or a combination comprising at least one of the foregoing. The dissociation may be endothermic and may be facilitated by supplying heat to the transfer fluid to heat it above the dissociation temperature.

In one embodiment, the associating composition may include salts and/or particulate solids and/or ionic liquids. In one embodiment, the salt may have a cation that may include alkaline earth metals, alkali metals, transition group metals, rare earth metals, or a combination including at least one of the foregoing cations. Non-limiting examples of suitable cations include lithium, sodium, potassium, cesium, berrylium, rubidium, magnesium, calcium, strontium, barium, yttrium, lanthanum, vanadium, niobium, tantalum, chromium, molybdenum, tungsten, cobalt, nickel, iron, copper, aluminum, tin, palladium, gold, silver, or the like, or a combination including at least one of the foregoing cations. Non-limiting examples of suitable anions include halides such as fluorides, chlorides, bromides, or iodides; nitrates, nitrites, sulfates, sulfites, selenides, tellurides, perchlorates, chlorates, chlorites, hypochlorites, carbonates, phosphates, borates, silicates, permanganates, chromates, dichromate, or the like, or a combination including at least one of the foregoing anions.

Non-limiting examples of suitable salts include strontium bromide, strontium chloride, calcium chloride, magnesium chloride, sodium chloride, potassium chloride, ammonium chloride, berrylium chloride, magnesium bromide, magnesium hypochlorite; calcium bromide, sodium bromide, calcium hypochlorite, barium bromide, barium chloride, manganese chloride, manganese bromide, ferric chloride, ferric bromide, cobalt chloride, cobalt bromide, nickel chloride, nickel bromide, nickel hypochlorite, chromium chloride, cadmium bromide, tantalum chloride, rhenium chloride, rhenium bromide, tin chloride, sodium tetrachloroaluminate, ammonium tetrachloroaluminate, potassium tetrachloroaluminate, ammonium tetrachlorozincate, (NH₄)₃ZnCl₅, potassium tetrachlorozincate, CsCuCl₃, K₂FeCl₅, or the like, or a combination including at least one of the foregoing salts. Exemplary salts include strontium bromide (SrBr₂), strontium chloride (SrCl₂), calcium chloride (CaCl₂), and magnesium chloride (MgCl₂).

In one embodiment, the associating composition may include an ionic fluid. The ionic fluids may be room temperature ionic liquids (RTILs) and may be composed of a cation and an anion, whose forces of attraction may not sufficiently strong to hold them together as a solid at ambient temperature. These salts are therefore liquids. RTILs may be organic fluids that contain nitrogen-based organic cations and inorganic anions. RTILs may include imidazolium or pyridinium cations having alkyl groups in the C₂ to C₈ range. Anions may include small inorganic species such as [BF₄]⁻, [PF₆]⁻, triflate [TfO]—CF₃SO₂⁻, nonaflate [NfO]—CF₃(CF₂)₃SO₂⁻, bistrifluoromethane sulfonimide [Tf2N]—(CF₃SO₂)₂N⁻, trifluoroacetate [TA]-CF₃CO₂⁻, heptafluorobutanoate [HB]—CF₃(CF₂)₃CO₂⁻ or [NO₃]⁻. This property may allow them to dissolve organic compounds and serve as potential solvents for industrially important organic reactions. Ionic liquids are environmentally friendly because they may have no detectable vapor pressure and they may also non-flammable. Examples of suitable RTILs that may associate with the working fluid include trimethylphenylammonium bistrifluoride, 1,3-butylmethylpyrrolidinium bistriflamide, 1,3-butylmethylimidazolium bistriflamide, 1,3-ethylmethylimidazolium bistriflamide, 1,3-ethylmethylpyrrolidinium bistriflamide, 1,3-trihexyltetradecanephosphonium bistriflate, butylmethylimidazolium hexafluorophosphate, butylmethylimidazolium tetrafluoroborate, ethylmethylimidazolium bis(trifluoromethanesulfonyl)amide, ethylmethylimidazolium trifluoromethanesulfone, and ethylmethylimidazolium dicyanamide, 1-butyl-3-methylimidazolium chloride, 1-butylpyridinum chloride, or the like, or a combination including at least one of the foregoing RTILs.

In one embodiment, in addition to the salts, the transfer fluid may also include other particulate solids such as, for example, zeolites (e.g., aluminum, sodium or calcium silicates), clay (e.g., aluminum silicate), or activated coal or carbon, or the like, or a combination including at least one of the foregoing particulate solids. Combinations of the salts with the particulate solids may also be used.

In one embodiment, the associating composition may be present in the transfer fluid in an amount of about 10 to about 90 weight percent, based on the total weight of the transfer fluid. In another embodiment, the associating composition may be present in the transfer fluid in an amount from about 10 weight percent to about 20 weight percent, from about 20 weight percent to about 40 weight percent, from about 40 weight percent to about 65 weight percent, from about 65 weight percent to about 80 weight percent, or from about 80 weight percent to about 90 weight percent based on the total weight of the transfer fluid.

In one embodiment, the working fluid may be any fluid that can undergo a thermally reversible association and/or dissociation with the associating composition. In one embodiment, the working fluid may be capable of being dissociated from the associating composition at a temperature T1. In order for the transfer fluid to reach the temperature T1, heat may be supplied either through thermal and/or fluid communication with the first fluid in the first heat exchanger 16 or alternatively by direct heat obtained from solar radiation and the like. The dissociation of the working fluid from the associating composition may be an endothermic process. In one embodiment, when the transfer fluid absorbs heat while in the first heat exchanger 16, the working fluid may dissociate to from the associating composition. The working fluid that dissociates from the associating composition may be at a higher pressure and temperature than the pressure and temperature in the transfer fluid. The working fluid may be permitted to expand and during this expansion contacts a movable surface of the first energy conversion device 12. In one embodiment, the movable surface may either undergo reciprocatory motion, rotary motion, or a combination of reciprocatory and rotary motion. The expansion of the working fluid may be converted into another form of energy (e.g., thermal to mechanical). In one embodiment, the energy conversion device may be a piston that may be in reciprocatory slideable communication with a cylinder. In one embodiment, the expansion of the working fluid may promote a reciprocatory motion of the piston within the cylinder. This reciprocatory motion may be converted into rotary motion, which may then converted into electrical energy via a generator.

In one embodiment, in the process of expansion, the working fluid may be cooled to a temperature T2, wherein T2 may be less than T1. The working fluid after expansion may be termed as the spent working fluid. In one embodiment, after expansion through the energy conversion device, the spent working fluid may be optionally cooled further to a temperature T3, wherein T3 may be less than T2. The temperature T3 may be a temperature at which association of the spent working fluid with the spent associating composition takes place. In one embodiment, the temperature T3 may be equal to T2, and there may be no need for additional cooling.

In one embodiment, this association may be accompanied by an exotherm. The association of the spent working fluid into the spent associating composition at a specific temperature (e.g., at the temperature T3) may create a low pressure. A coolant may remove the heat generated by the association. In one embodiment, both, the first absorber 8 and the first heat exchanger 16 may be provided with a cooling loop to remove the heat generated by the exotherm.

In one embodiment, a suitable working fluid may be a liquid or gas that may have a dipole moment and may also be capable of undergoing covalent bond-breaking reactions. Suitable working fluids may be polar protic solvents and dipolar aprotic solvents. Non-limiting examples of suitable working fluids may be ammonia, alcohols (e.g., methanol, ethanol, butanol); water; carbon dioxide; hydrogen; amines (e.g., pyrrole, pyridine, methyl amine, dimethyl amine, trimethyl amine); ethers; glycols; glycol ethers; sebacates; phthalates (e.g., diethylhexylphthalate (DEHP), monoethylhexylphthalate (MEHP), dimethylphthalate (DMP), butylbenzylphthalate (BBP), dibutylphthalate (DBP), dioctylphthalate (DOP)); aldehydes (e.g., acetaldehydes, propionaldehydes), formamides (e.g., N,N-dimethylformamide); ketones (e.g., acetone, methyl ethyl ketone, β-bromoethyl isopropyl ketone); acetonitrile; sulfoxides (e.g., dimethylsulfoxide, diphenylsulfoxide, ethyl phenyl sulfoxide); sulfones (e.g., diethyl sulfone, phenyl 7-quinolylsulfone); thiophenes (e.g., thiophene 1-oxide); acetates (e.g., ethylene glycol diacetate, n-hexyl acetate, 2-ethylhexyl acetate); amides (e.g., propanamide, benzamide) or the like, or a combination including at least one of the foregoing fluids. In one embodiment, the working fluid may be ammonia.

In one embodiment, when the associating composition may be contacted with the working fluid, the resulting complex may be an ammoniated complex, a hydrated amine, an alcohol complex compound, metal hydrides, metal oxide-metal carbonate, metal oxide-metal hydroxide complexes, or the like, or a combination including at least one of the foregoing compounds. Non-limiting examples of suitable complexes formed by contacting the associating composition with the working fluid may be BeCl₂.X(NH₃), wherein X may be about 2 to about 4; MgCl₂.X(NII₃) wherein X may be about 2 to about 6; MgBr₂.X(NII₃), wherein X may be about 2 to about 6; Mg(ClO₄)₂.X(NH₃), wherein X may be about 0 to about −6; CaCl₂.X(NH₃), wherein X may be about 2 to about 4; CaCl₂.X(NH₃), wherein X may be about 4 to about 8; CaBr₂.X(NH₃), wherein X may be about 2 to about 6; Ca(ClO₄)₂.X(NH₃), wherein X may be about 2 to about 6; SrCl₂.X(NH₃), wherein X may be about 1 to about 8; SrBr₂.X(NH₃), wherein X may be about 2 to about 8; Sr(ClO)₂.X(NH₃), wherein X may be about 0 to about 6; BaBr₂.X(NH₃), wherein X may be about 4 to about 8; BaCl₂.X(NH₃), wherein X may be about 0 to about 8; MnCl₂.X(NH₃), wherein X may be about 2 to about 6; MnBr.X(NH₃), wherein X may be about 2 to about 6; FeCl₂.X(NH₃), wherein X may be about 3 to about 6; FeBr₂.X(NH₃), wherein X may be about 2 to about 6; COCl₂.X(NH₃), wherein X may be about 2 to about 6; CoBr₂.X(NH₃), wherein X may be about 2 to about 6; NiCl₂.X(NH₃), wherein X may be about 2 to about 6; NiBr₂.X(NH₃), wherein X may be about 2 to about 6; Ni(ClO₃)₂.X(NH₃), wherein X may be about 0 to about 6; CrCl₂.X(NH₃), wherein X may be about 0 to about 3 and about 3 to about 6; CdBr₂.X(NII₃), wherein X may be about 2 to about 6; TaCl₃.X(NII₃), wherein X may be about 0 to about 7; ReCl₃.X(NH₃), wherein X may be about 0 to about 6; ReBr₃.X(NH₃), wherein X may be about 0 to about 7; SnCl₂.X(NH₃), wherein X may be about 0 to about 2.5; NH₄AlCl₄.X(NH₃), wherein X may be about 0 to about 6; NaAlCl₄.X(NH₃), wherein X may be about 0 to about 6; KAlCl₄.X(NH₃), wherein X may be about 0 to about 6; (NH₄)₂ZnCl₄.(NH₃), wherein X may be about 0 to about 4; (NH₄)₃ZnCl₅.X(NH₃), wherein X may be about 0 to about 6; K₂ZnCl.X(NH₃), wherein X may be about 0 to about 5; K₂ZnCl₄.X(NH₃), wherein X may be about 5 to about 12; CsCuCl₃.X(MH₃), wherein X may be about 2 to about 5; K₂FeCl₅.X(NH₃), wherein X may be about 2 to about 5; NH₄Cl.X(NH₃), wherein X may be about 0 to about 3; NaBr.X(NH₃), wherein X may be about 0 to about 5.25; CaCl₂.XH₂O, wherein X may be about 1 to about 4; or the like, or a combination comprising at least one of the foregoing complexes. In one embodiment, the complexes formed by contacting the associating composition with the working fluid may be SrBr₂.8NH₃, SrCl₂.8NH₃, CaCl₂.NH₃, MgCl₂.NH₃ and CaCl₂.H₂O.

In one embodiment, the working fluid may be present in the transfer fluid in an amount of about 10 weight percent to about 90 weight percent, based on the total weight of the transfer fluid. In one embodiment, the working fluid may be present in the transfer fluid in an amount from about 10 weight percent to about 20 weight percent, from about 20 weight percent to about 40 weight percent, from about 40 weight percent to about 65 weight percent, from about 65 weight percent to about 80 weight percent, or from about 80 weight percent to about 90 weight percent based on the total weight of the transfer fluid.

The transfer fluid, in certain embodiments, may include a carrier fluid in addition to the working fluid and the associating composition. In one embodiment, the carrier fluid may have some affinity for the working fluid. In one embodiment, the carrier fluid may dissolve the working fluid. In another embodiment, the carrier fluid may undergo a reaction with working fluid to form a complex. In one embodiment, the carrier fluid may have a vapor pressure considerably lower than the partial pressure of the working fluid. The difference between the vapor pressure and the partial pressure should prevail throughout the entire operating range of the process. In one embodiment, there may be at least a 25 degrees Celsius difference between the boiling points of the carrier fluid and the working gas. In another embodiment, the carrier fluid may be in the liquid state during the association and dissociation stages of the process.

In one embodiment, a suitable carrier fluid may have a greater affinity for the working fluid than it does for the associating composition. For example, suitable carrier fluids may not promote dissolution of the associating composition to any considerable extent or agglomeration of the associating composition so that mass diffusion might otherwise be hindered during association or dissociation. The carrier fluid may not occupy any sites on the associating composition that may be used by the working fluid to associate with the salts and/or the particulate solid. In addition, the carrier fluid may be able to maintain the associating composition in a suspension that may be pumped.

In one embodiment, the carrier fluid may evaporate at the same temperature as the working fluid. In such a case the carrier fluid may undergo expansion along with the working fluid when the vapors contact the moving surface of the energy generation device.

Examples of suitable carrier fluids may be long chain alcohols having at least seven carbon atoms and the isomers thereof (e.g., octanol, heptanol); ethers, glycols (e.g., diethylene glycol), glycol ethers (e.g., diethylene glycol diethyl ether); sebacates (e.g., diethyl sebacate); phthalates (e.g., diethyl phthalate); aldehydes (e.g., succinaldehyde) and ketones, or the like, or a combination including at least one of the foregoing. In one embodiment, the carrier fluid may be heptanol.

In one embodiment, the carrier fluid may be present in the transfer fluid in an amount of about 1 to about 80 weight percent, based on the total weight of the transfer fluid. In another embodiment, the carrier fluid may be present in the transfer fluid in an amount of from about 1 weight percent to about 15 weight percent, from about 15 weight percent to about 30 weight percent, from about 30 weight percent to about 45 weight percent, from about 45 weight percent to about 65 weight percent, or from about 65 weight percent to about 80 weight percent, based on the total weight of the transfer fluid.

In certain embodiments, the formation of the transfer fluid may be carried out by first forming a mixture of the carrier fluid and the associating composition and then introducing the working fluid into the mixture. In another embodiment, the working fluid may be first mixed with the associating composition prior to the addition of the carrier fluid. In yet another embodiment, the working fluid may be first dissolved in the liquid carrier prior to associating with the associating composition. In one embodiment, the mixing of the working fluid with the liquid carrier and the associating composition may be conducted in identical vessels or separate vessels if so desired.

In one embodiment, the transfer fluid may include the working fluid and the associating composition and may be in the form of a slurry. In another embodiment, the transfer fluid may include the working fluid, the associating composition and the carrier fluid and may be in the form of a slurry. In yet another embodiment, the transfer fluid includes the working fluid, the associating composition and the carrier fluid and may not be in the form of a slurry. The term “slurry” as used herein may be a mixture of the associating composition with the carrier fluid, wherein association between the working fluid and the associating composition may take place. In a slurry at least a portion of the associating composition may be insoluble in the carrier fluid.

In one embodiment, the heat of association/dissociation between the working fluid and the associating composition may be greater than equal to about 500 kilojoules per kilogram (kJ/Kg). In one embodiment, the heat of association/dissociation between the working fluid and the associating composition may in a range from about 500 kilojoules per kilogram to about 750 kilojoules per kilogram, from about 750 kilojoules per kilogram to about 900 kilojoules per kilogram, from about 900 kilojoules per kilogram to about 1050 kilojoules per kilogram, from about 1050 kilojoules per kilogram to about 1250 kilojoules per kilogram, from about 1250 kilojoules per kilogram to about 1750 kilojoules per kilogram, from about 17500 kilojoules per kilogram to about 2000 kilojoules per kilogram, from about 2000 kilojoules per kilogram to about 2250 kilojoules per kilogram, from about 2250 kilojoules per kilogram to about 2500 kilojoules per kilogram, from about 2500 kilojoules per kilogram to about 2750 kilojoules per kilogram, from about 2750 kilojoules per kilogram to about 3000 kilojoules per kilogram, or from about 3000 kilojoules per kilogram to about 3750 kilojoules per kilogram. In another embodiment, the heat of association/dissociation between the working fluid and the associating composition may be greater than or equal to about 37500 kilojoules per kilogram. In one embodiment, the large value of the heat of association/dissociation, large amount of heat may be input into the transfer fluid in order to separate the working fluid from the associating composition.

In one embodiment, when the working fluid may be separated from the associating composition, it may be at a high pressure and a high temperature T1. The working fluid may then expanded in an energy conversion device to produce electrical energy. In one embodiment, when the working fluid may be dissociated from the associating composition it may be at a temperature of about 120 degrees Celsius to about 500 degrees Celsius and a pressure of about 3,200 kiloPascals (kPa) to about 17,800 kiloPascals. In another embodiment, when the working fluid may be dissociated from the associating composition it may be at a temperature of about 150 to about 450 degrees Celsius and a pressure of about 4,000 kPa to about 16,000 kiloPascals. In yet another embodiment, when the working fluid is dissociated from the associating composition it is at a temperature of about 200 to about 420 degrees Celsius and a pressure of about 5,000 kPa to about 15,000 kiloPascals.

In one embodiment, the energy conversion device 12 may facilitate the conversion of the energy of expansion of the working fluid to electrical energy. The expansion of the working fluid may be used to produce reciprocatory motion in an energy conversion device. The reciprocatory motion can be converted to rotary motion and the rotary motion can be used to drive an electrical motor (i.e., generator/alternator) that can generate electricity. In one embodiment, the expanding working fluid contacts a piston that is in slideable reciprocatory motion with a cylinder. The reciprocatory motion of the piston can be converted into rotary motion via a crankshaft. This rotary motion can then be used to drive an electrical generator to generate electricity.

When the energy conversion device 12 is a piston that is in slideable reciprocatory motion with a cylinder, the working fluid under pressure P1 undergoes expansion in the cylinder thereby displacing the piston. Following the displacement of the piston, the working fluid exits the piston at a pressure P2 that is less than P1.

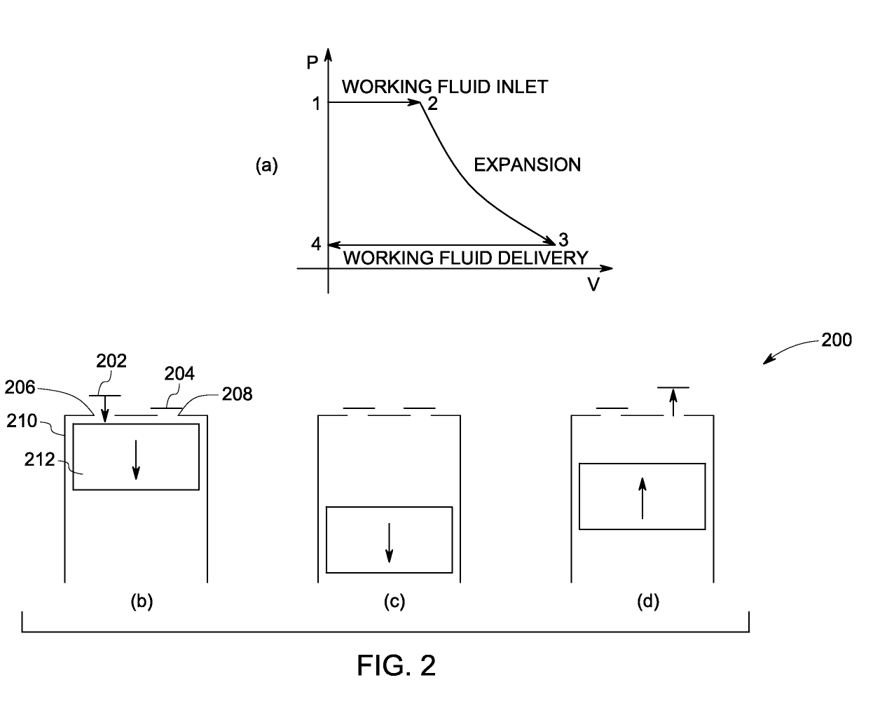

In some embodiments, the energy conversion device 12 can be a 2 stroke or a 4 stroke engine. In one embodiment, the energy conversion device 12 is a 2-stroke engine. In one embodiment, the energy conversion device 12 comprises a 2-stroke engine and a 4-stroke engine in operative communication with a crankshaft. In one embodiment, the energy conversion device comprises a plurality of pistons in reciprocatory communication with a plurality of cylinders, wherein a portion of the pistons are displaced by the working fluid and wherein the remainder of the pistons are displaced by a hydrocarbon fuel. The pistons that are displaced by the working fluid do not experience combustion, while those displaced by the hydrocarbon fuel experience combustion. FIG. 2(a) is a graphical representation of the pressure volume relationship in a cylinder during a 2-stroke cycle.

FIG. 2(b) depicts a reciprocating engine energy conversion device 12 during a two stroke cycle. With reference now to the FIGS. 2(a) and (b), when the energy conversion device 12 is a 2-stroke engine 200, the intake valve 202 opens for a short duration to allow high-pressure working fluid to enter through the inlet port 206 into the engine cylinder 210 during the downward stroke of the piston 212. During the downward (intake) stroke, the piston 212 travels from the top dead center (TDC) to the bottom dead center (BDC) of the engine cylinder 210. During the return (exhaust) stroke, i.e., when the piston 212 is displaced from the bottom dead center to the top dead center, low-pressure working fluid is discharged from the engine cylinder 210 through the outlet port 208, while the outlet valve is displaced upwards by the compressed working fluid. The valves 202 and 204 are displaced by cams

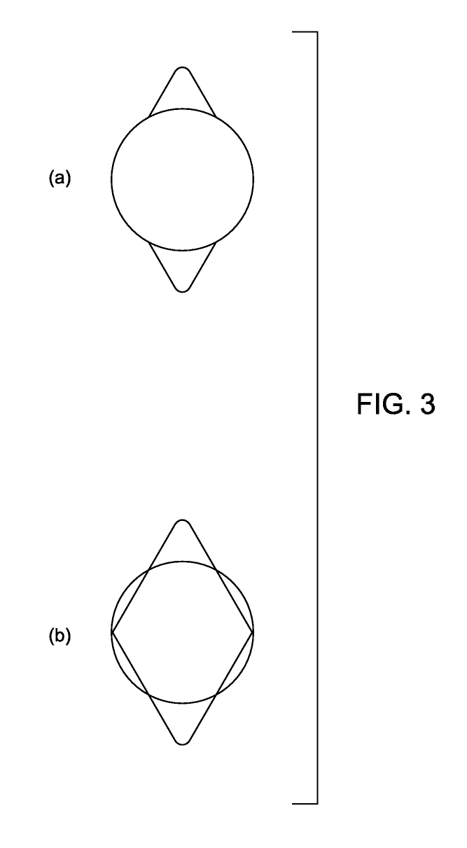

In another embodiment, the energy conversion device 12 is a 4-stroke engine, whose respective valves are displaced by multi-lobed cams as depicted in the FIG. 3. The multi-lobed cams can have two or more lobes. An exemplary lobed cam has two lobes. FIG. 3(a) is an exemplary depiction of a two lobed cam used in the intake stroke, while FIG. 3(b) is an exemplary depiction of the two lobed cam used in the exhaust stroke. The use of two lobed cams promotes the working fluid to expand under high pressure into the cylinder twice during a single cycle of the engine. With reference now to the FIG. 3(a), when a two lobed cam is used, the working fluid under high pressure expands into the cylinder through the inlet port 208 twice during the intake stroke of the piston from the top dead center to the bottom dead center. Similarly, during the compression of the ammonia gas the use of the two lobed cam seen in the FIG. 3(b) permits the ammonia gas to undergo two stages of compression as the piston travels from the bottom dead center to the top dead center during the exhaust stroke.

As noted above, the 4-stroke engine having the multi-lobed cams can be incorporated into an internal combustion engine that uses gasoline, diesel, or the like. For example, in a multi-cylinder engine, 1 or 2 cylinders can be used to facilitate an energy conversion using the working fluid and based upon the thermo-chemical energy recovery, while the remaining cylinders can be used to generate energy by combusting a hydrocarbon fuel such as gasoline, diesel, kerosene, or the like. Thus, up to 75% of the cylinders in a multi-cylinder engine can employ the working fluid for purposes of energy generation. All of the cylinders (those that are displaced by the working fluid and those that are displaced by combustion of the hydrocarbon fuel) can be in operative communication with a single crankshaft.

After expansion into the energy conversion device, the spent working fluid is at a lower temperature T2 than the temperature T1 prior to expansion. After expansion into the energy conversion device 12, the spent working fluid is at a temperature of about 25 degrees Celsius to about 150 degrees Celsius and a pressure of about 60 kPa to about 170 kPa. In another embodiment, after expansion into the energy conversion device, the spent working fluid is at a temperature of about 60 degrees Celsius to about 140 degrees Celsius and a pressure of about 70 kPa to about 150 kPa. In yet another embodiment, after expansion into the energy conversion device, the spent working fluid is at a temperature of about 70 degrees Celsius to about 120 degrees Celsius and a pressure of about 80 kPa to about 140 kPa.

In one exemplary embodiment, the spent working fluid may exit the energy conversion device 12 at a temperature of about 25 degrees Celsius to about 150 degrees Celsius and at a pressure of about 50 to about 500 kPa. Such an embodiment may apply in one instance where, the transfer fluid may include SrCl₂.8NH₃, which may be derived from a working fluid including ammonia and an associating composition including strontium chloride. The temperature and pressure ranges other than the aforementioned temperature and pressure ranges may apply when a transfer fluid comprises SrCl₂.8NH₃.

In one embodiment, the system efficiency as a percentage of Carnot efficiency of the system 10 may be greater than or equal to about 15%. In another embodiment, the efficiency of the system 10 may be in a range from about 15% to about 25%, from about 25% to about 30%, from about 30% to about 45%, or from about 45% to about 50%. In yet another embodiment, the efficiency of the system 10 may be greater than about 50%.

In one embodiment, with reference to the FIG. 1, the spent working fluid, after expanding in the energy conversion device 12, may be transferred to a heat exchanger, such as, for example, the first absorber 8 or the first heat exchanger 16, where the association of the working fluid with the associating composition occurs. In one embodiment, the spent working fluid exiting the energy conversion device may be optionally cooled to the temperature at which it may undergo association with the associating composition. In one embodiment, since the association of the working fluid with the associating composition may exothermic and generates heat, the excess heat generated may be removed. This may either be accomplished by a suitable heat transfer mechanism such as the use of fans, fins, baffles, or the like. In another embodiment, the excess heat generated may used as a supplemental form of energy, thereby improving the efficiency of the system 10.

In one embodiment, the system 10 may be operated in batch mode or in a continuous mode. In a batch mode, the dissociation of ammonia may occur intermittently and electricity may be generated intermittently. However, this mode of intermittent energy generation may be combined with other methods of energy generation such as, for example, nuclear, hydrothermal, or the like, to continuously generate electrical energy.

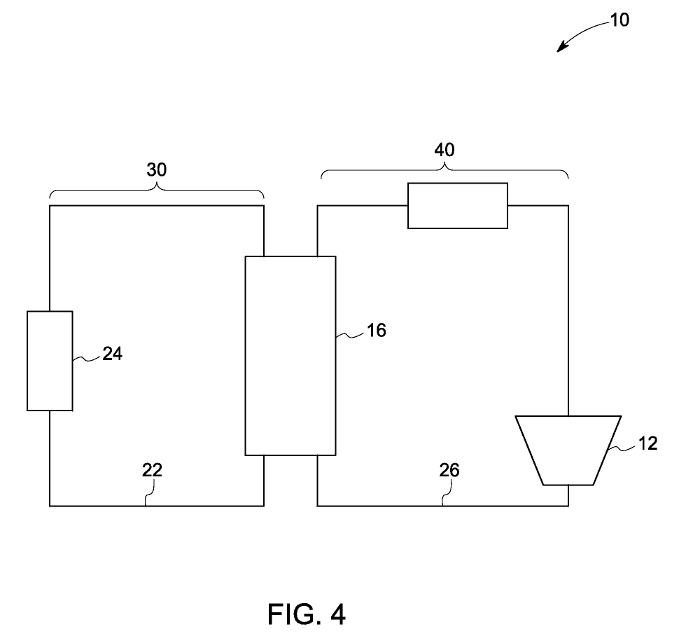

In one embodiment, the method, of using the system 10 in either a batch mode or in a continuous mode as depicted in the FIG. 4, the system includes a heat supply system 30 including a first pipe 22 in thermal and/or fluid communication with a first heat exchanger 16. In one embodiment, the pipe may be in physical contact with heat source 24. In one embodiment, the first pipe 22 may form a closed loop 30 and may facilitate the movement of the first fluid. In another embodiment, the first pipe may be open to the environment and may exhaust the first fluid directly to the environment. In another embodiment, the first pipe 22 may exhaust the first fluid to a treatment facility.

In one embodiment, the closed loop 40 includes the first heat exchanger 16, a first absorber 8 and the first energy conversion device 12. In one embodiment, the first energy conversion device 12 may include an energy conversion device or a work extraction device. The closed loop 40 may facilitate the movement of the transfer fluid. Upon being heated in the first heat exchanger 16 by thermal energy may be absorbed from the first fluid, the transfer fluid may dissociate into the associating composition and the working fluid. In one embodiment, the working fluid may be in gaseous form. The working fluid may expand into the energy conversion device, while the associating composition, may be stripped of the association with the working fluid, may be left behind in the first heat exchanger 16. In one embodiment, after the working fluid may be dissociated from the associating composition, the associating composition may be pumped to a first absorber 8 where it may be mixed with the spent working fluid. In one embodiment, the spent working fluid may be the working fluid that may have undergone expansion in the energy conversion device. An optional accumulator may be used to store the working fluid after dissociation. The working fluid may then be expanded through the energy conversion device. The accumulator may be used to smooth the non-uniformity in the flow of the working gas to the energy conversion device. In particular embodiments, the expansion of the working fluid in the energy conversion device may be used to generate electricity.

In one embodiment, the first absorber 8 may be a heat exchanger adapted to receive the spent associating composition from the first heat exchanger 16 and the spent working fluid from the first energy conversion device 12. In one embodiment, the spent associating composition and the spent working fluid may associate in the absorber to produce the transfer fluid. This association may be accompanied by an exotherm. In one embodiment, the transfer fluid after the association may be transferred back to the first heat exchanger 16 to undergo dissociation, thus completing the cycle. It may be noted that the first absorber 8 may be replaced by the first heat exchanger 16, if the first heat exchanger 16 is modified so that it may be used for both the association and dissociation. In this case, parts of heat exchanger 16 may act as an absorber, where association of the working fluid with the associating composition may take place followed by an exotherm, whereas other parts of heat exchanger 16 may act as desorber where heat may absorbed and dissociation of the working fluid may take place.

In one embodiment, when the system is used in the batch mode, after the removal of the working fluid from the heat exchanger, using a two-way valve may stop the pumping of the first fluid through the heat supply system 30. In one embodiment, after the working fluid is expanded through the energy conversion device, it may be contacted again with the associating composition in the first absorber 8 to form the transfer fluid. Association between the associating composition and the working fluid in the first absorber 8 may accompany by an exotherm. The heat generated by the exotherm in the first absorber 8 may be removed by the use of a coolant. In one embodiment, after the removal of heat from the transfer fluid it may be transferred to the first heat exchanger 16 from the first absorber 8 to undergo dissociation.

In one embodiment, the heat generated by this exotherm may be extracted and used for the generation of additional energy. In one embodiment, the removal of the generated heat may promote the cooling of the transfer fluid to a desired temperature. The removal of the generated heat may be accomplished by the use of a cooling fluid such as water. In some embodiments, the heat removed may be sufficient to convert the water into steam, which may be used to drive an energy conversion device or other energy conversion device, thereby generating energy. Upon the removal of the heat generated by the exotherm, the two-way valve in the heat supply system 30 may once again be opened. In another embodiment, the system 10 of FIG. 4 may be used to continuously generate energy in the energy conversion device. The opening of the valve may permit the association of the working fluid with the solid composition following which the cycle may be continued. In one embodiment, when the system 10 of FIG. 4 may be used in the continuous mode, the first absorber 8 may contain a quantity of the transfer fluid, which may be transferred to the first heat exchanger 16 after the transfer fluid in the heat exchanger may be dissociated. In one embodiment, when the working fluid from the first heat exchanger 16 is dissociated from the associating composition, it may be expanded through the energy conversion device 12. During the expansion of the working fluid through the energy conversion device 12, the associating composition may be transferred to the first absorber 8. At the same time, the reserve quantity of the transfer fluid may transferred from the first absorber 8 to the first heat exchanger 16, where it may begin the dissociation process. In one embodiment, the spent associating composition that may have been transferred to the first absorber 8, may undergoe association with the spent working fluid after it may have been expanded to re-form the transfer fluid. The process may be repeated, thereby continuously generating energy.

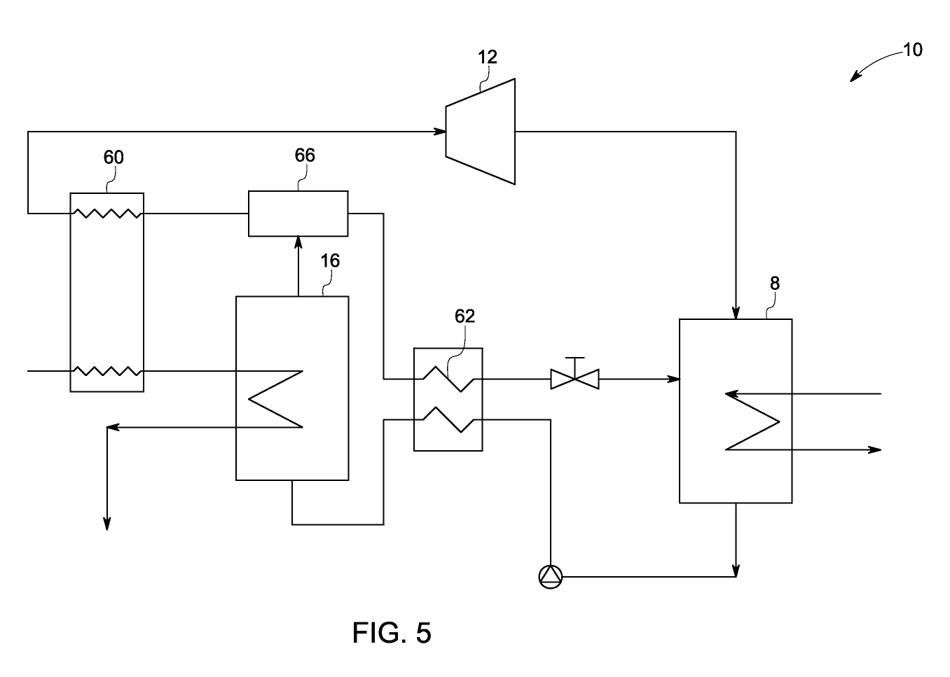

FIG. 5 shows another embodiment, of the system 10 that may be continuously used to generate energy. In the FIG. 5, the system 10 includes a first heat exchanger 16, a separator 66, a superheater 60, a first energy conversion device 12, a first absorber 8 and a regenerator 62. It may be noted that the separator 66, the superheater 60 and the regenerator 62 may be optional features. In the FIG. 5, the first energy conversion device 12 may be located downstream of the first heat exchanger 16. In one embodiment, the first energy conversion device 12 may be located downstream of the separator 66 and the superheater 60. The separator 66 and the superheater 60 may be in thermal and/or fluid communication with the first heat exchanger 16 and the first energy conversion device 12. The first absorber 8 may be downstream of the first energy conversion device 12. Disposed between the first absorber 8 and the first heat exchanger 16 may be the regenerator 62. The regenerator may be in fluid communication with the first heat exchanger 16 and the first absorber 8.

In one embodiment, the first fluid including an exhaust gas at a temperature T1, may be passed through a superheater 60 and then through a first heat exchanger 16. In one particular embodiment, strontium chloride may be used as the associating composition, while ammonia may serve as the working fluid and heptanol may be used as the carrier fluid. In one embodiment, when the exhaust gas passes through the first heat exchanger 16, it may dissociate the transfer fluid into a working fluid and an associating composition. In one embodiment, the working fluid upon being dissociated may be transferred to the superheater 60 where may it pick up additional heat from the exhaust gas. The working fluid may then transferred to the first energy conversion device 12, where it may expand and may contact the moving surfaces of the first energy conversion device 12 to produce energy. The spent associating composition may be entrained in the carrier fluid, may be transferred to a regenerator 62, and may then be transferred to the first absorber 8, where it may associate with the spent working fluid to re-form the transfer fluid. As noted above, this association may be accompanied by an exotherm. In one embodiment, a cooling fluid may be used to remove the heat generated as a result of the exotherm. The re-formed transfer fluid may be then transferred to the first heat exchanger 16 via the regenerator 62. The regenerator 62 may heat the transfer fluid after the transfer fluid exits the absorber. The regenerator 62 may be located downstream of the first absorber 8 and upstream of the heat exchanger 16. The regenerator may use the heat from the “spent” transfer fluid from the heat exchanger, 16, to preheat the “regenerated” transfer fluid from the absorber upstream of the heat exchanger. In this manner, the regenerator may increase the efficiency of the cycle by internally exchanging heat from where heat may need to be rejected (“spent” transfer fluid from heat exchanger, 16) to where it may be added (“regenerated” transfer fluid from absorber 8).

The system 10 of FIG. 5 may have pumps in fluid communication with the heat exchanger 16 and 60 and the absorber 8. It may also have a pressure regulators disposed between the heat exchanger and the absorber. The system may also have a separator that may be used to separate working fluid vapor from the associating composition after the dissociation may have taken place in the first heat exchanger 16.

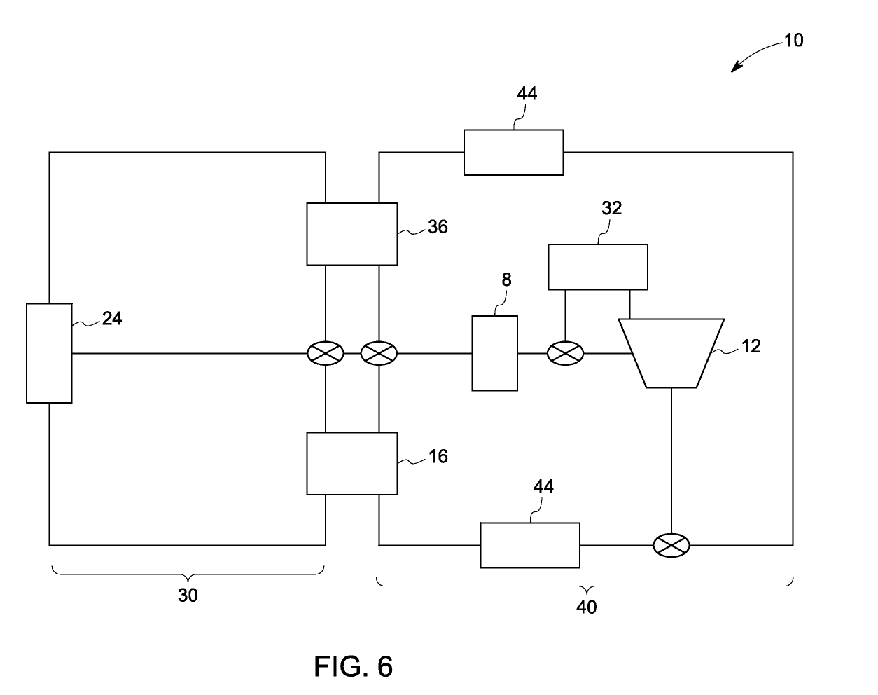

In another embodiment, in another manner of using the system 10 to continuously generate energy in the energy conversion device, the heat supply system 30 and the closed loop 40 include at least two heat exchangers, a first heat exchanger 16 and a second heat exchanger 36. This mode of operation of the system 10 is depicted in the FIG. 6. The embodiment depicted in the FIG. 6 may also be used to generate energy in a batch mode if desired. Both heat exchangers may be in thermal and/or fluid communication with the heat source 24 as well as the energy conversion device 12. In one embodiment, pertaining to the operation of the system 10, heated first fluid in the heat supply system 30 may be alternated between the first and the second heat exchangers in a manner effective to promote the sequential dissociation of the working fluid in the first and the second heat exchangers. The sequential dissociation may be arranged so that the working fluid in the first heat exchanger 16 may be completely dissociated from the associating composition prior to dissociating the working fluid in the second heat exchanger 36. Alternatively, the dissociation in the first heat exchanger 16 may be arranged to precede the dissociation in the second heat exchanger 36 by a certain selected time interval. If the dissociation in the first heat exchanger 16 may be arranged to precede the dissociation in the second heat exchanger 36 by a time interval that may be greater than the time taken for the dissociation in the first heat exchanger 16, then the system 10 may be made to operate as a batch system.

In one embodiment, when the first fluid may be fed to the first heat exchanger 16, thereby establishing thermal and/or fluid communication between heat source 24 and first heat exchanger 16, dissociation of the working fluid from the associating composition may take place in the first heat exchanger. In another embodiment, when the first fluid is fed to the second heat exchanger 36, thereby establishing thermal and/or fluid communication between heat source 24 and second heat exchanger 36, dissociation of the working fluid from the associating composition may take place in the second heat exchanger 36. The working fluid that is dissociated in each case may be fed to the first energy conversion device 12 to generate electricity. In certain embodiments, the working fluid that is dissociated may be simultaneously fed to the first energy conversion device 12 to generate electricity.

In one embodiment, on being expanded in the first energy conversion device 12, the spent working fluid from the first heat exchanger 16 may be returned to the first absorber 8 while the working fluid from the second heat exchanger 36 may be returned either to the first absorber 8 or to a separate absorber. In another embodiment, after expansion in the first energy conversion device 12, the spent working fluid from the first heat exchanger 16 may be returned to the second heat exchanger 36, which may be acting as an absorber, and vice versa.

In one embodiment, the associating composition left behind after the dissociation may be pumped to a first absorber 8 where it may undergo association with the spent working fluid to re-form the transfer fluid. The removal of the heat may cool the transfer fluid in the absorber. This transfer fluid may be then transferred to the heat exchangers 16 and 36 where it may again be dissociated using heat from the heat source 24.

In one embodiment, the method of operating the system 10 may facilitate a continuous operation of the system and a continuous generation of energy. In one embodiment, the system 10 may include at least two heat exchangers as well as at least two energy conversion devices that may be used to generate energy continuously.

In yet another embodiment, the system 10 of FIG. 4 or FIG. 6 may be used as an energy storage device. In one embodiment, in the use of the system as an energy storage device, the working fluid after expansion in the energy conversion device may be condensed into a storage device 32, where it may be stored in the form of a liquid. An exemplary depiction of the system 10 containing storage devices 32 or 44 is shown in the FIG. 6. The storage devices 32 and/or 44 may include condensers to condense the working fluid to a liquid. They may also be used to store the working fluid in vapor or liquid form.

In one embodiment, when additional energy may be desired during periods of low energy generation or during periods of peak energy demand, the working fluid from the storage device 44 may be pumped to the absorber 8 to associate with the associating composition. Because the association is exothermic, heat may be liberated which may be used for generating additional energy. The heat from the exotherm may be used to convert a cooling fluid such as water to steam, which may be used to drive an energy conversion device or other form of energy conversion device.

The working fluid from the heat exchangers 16 and 36 may be stored in a storage device 44 either as a liquid or in vapor form. The liquid or vapor may then be expanded into the energy conversion device 12 as detailed above to generate electrical energy. In one embodiment, the system 10 may utilize energy derived from the braking systems of vehicles, such as locomotives powered by diesel engines or other suitable engines.

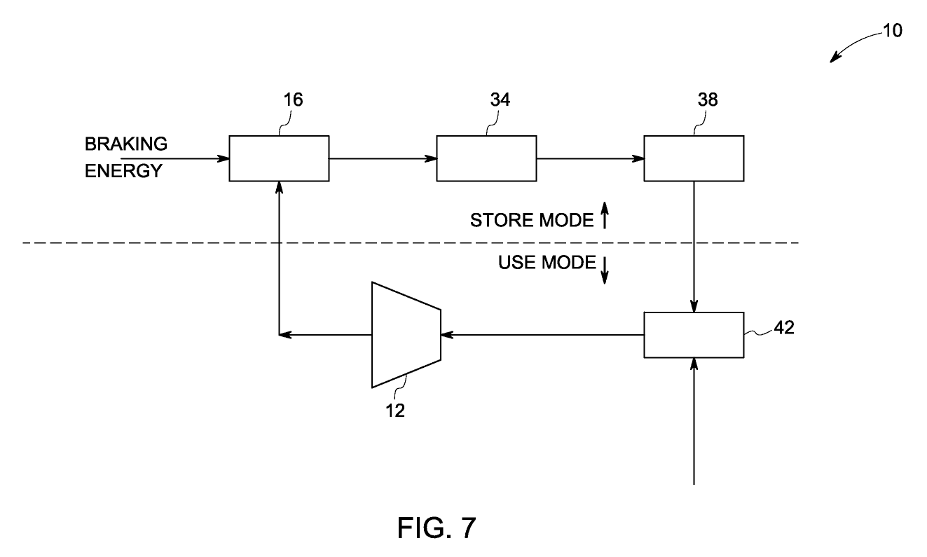

FIG. 7 is a schematic depiction of one embodiment of the system 10 that may be utilized to convert energy from the braking systems of locomotives into electrical energy. The locomotives may be, for example, steam locomotives, diesel locomotives or electrical locomotives. In one embodiment of the type shown in FIG. 7, the system 10 may be used for converting braking energy into electrical energy to drive the locomotive including a storage system (depicted as the store mode) and a user system (depicted as the use mode). The storage system includes a first heat exchanger 16, a condenser 34 and a reservoir 38, while the user system includes an evaporator 42 and an energy conversion device.

In one embodiment, in the “store mode” heat derived from braking may be used to dissociate the working fluid from the associating composition. The working fluid may then be condensed in the condenser 34 and may be stored in the reservoir 38 as a liquid. In one embodiment, when energy may have to be delivered to the engine for purposes of moving a load such as, for example, goods, passengers, or the like, the liquid from the reservoir may be pumped to the evaporator 42, where energy from the exhaust system of the locomotive may be used to heat the working fluid. The heated working fluid may be expanded through an energy conversion device to generate electrical energy that may be used to drive the locomotive. In one embodiment, the use of braking energy and exhaust energy for generating electricity may reduce the fuel consumption of a diesel locomotive by an amount of greater than or equal to about 10%. In one embodiment, the fuel consumption of a diesel engine may be reduced by an amount in a range from about 10% to about 15%, from about 15% to about 20%, or from about 20% to about 35%. In one embodiment, the system may be used as an auxiliary power unit to keep the engine warm instead of idling the engine thereby saving more fuel. In this case, the liquid ammonia from 38 may be bled into the first heat exchanger 16 (which already may contain the associating composition). This association may produce heat, which may be carried away by another fluid such as, for example, engine cooling water to keep the engine and other components warm.

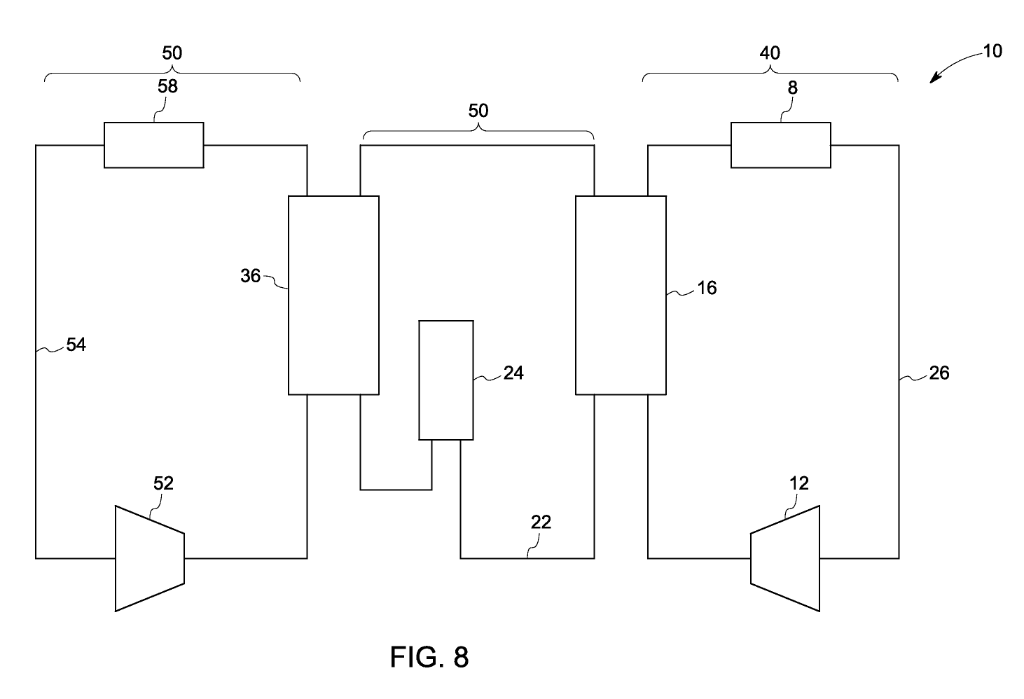

In one embodiment, the system 10 may be designed to work in stages as depicted in FIG. 8. The system 10 includes multiple systems that may be arranged in a manner so as to use the heat from the heat source 24 in series. As depicted in the FIG. 8, the system 10 includes a heat supply system 30 that includes a heat source 24, a first heat exchanger 16 and a second heat exchanger 36. As noted above, the heat supply system 30 may be a closed loop. In another embodiment, the heat supply system 30 may use exhaust heat from a reactor or an internal combustion engine, in which case the exhaust may be released directly to the atmosphere or to a treatment facility. The second heat exchanger 36 may be down stream of the first heat exchanger 16 and in thermal and/or fluid communication with it, while both heat exchangers may be down stream of the heat source 24 and in thermal and/or fluid communication with the heat source 24. A pipe 22 may provide the thermal and/or fluid communication in the heat supply system 30 and may facilitate the transfer of the first fluid. A first closed loop 40 includes the first heat exchanger 16, the energy conversion device 12 and a first absorber 8. A pipe 26 may provide the thermal and/or fluid communication between the first heat exchanger 16, the energy conversion device 12 and the first absorber 8. The first absorber 8 is downstream of the energy conversion device 12, while the energy conversion device 12 may be downstream of the first heat exchanger 16. The heat supply system 30 and the first closed loop 40 may be in thermal and/or fluid communication with each other via the first heat exchanger 16.

In one embodiment, the system 10 may include a second closed loop 50 that includes the second heat exchanger 36, a second energy conversion device 52 and an optional second absorber 58. The optional second absorber 58 may be replaced by the first absorber 8. The second energy conversion device 52 may be downstream of the second heat exchanger 36, while the optional second absorber 58 may be downstream of the second energy conversion device 52. In one embodiment, a pipe 54 keeps the second heat exchanger 36, the second energy conversion device 52 and the optional second absorber 58 may be in thermal and/or fluid communication with one another. The heat supply system 30 and the second closed loop may be in thermal and/or fluid communication with one another via the second heat exchanger 36. The second closed loop may facilitate the movement of a second transfer fluid, which includes an associating composition and a working fluid. In one embodiment, the second transfer fluid may be similar in composition to the transfer fluid. In another embodiment, the second transfer fluid may be different in composition from the transfer fluid.

In one embodiment, in the working of the multistage system 10 for power generation, a portion of the heat contained in the first fluid may be utilized to dissociate the transfer fluid that may flow in the closed loop 40. Following the dissociation, the remaining heat contained in the first fluid may be used to dissociate a second transfer fluid that flows in the second closed loop 50. The dissociation of the second transfer fluid may be used to generate additional electrical energy in the second energy conversion device 52.

In one embodiment, the first absorber 8 may be the same as the second absorber 58. In such an event, the multistage system 10 may employ one association temperature and two dissociation temperatures. The first dissociation temperature in the first heat exchanger 16 may be generally higher than the second dissociation temperature used in the second heat exchanger 36. The first heat exchanger 16 comprises one pressure stage, a high pressure stage. The high pressure stage may operate between a pressure corresponding to the first dissociation temperature or the second dissociation temperature. The second heat exchanger 36 includes one, low pressure stage. Spent working fluid from the second closed loop 50 may be mixed with spent working fluid from the heat supply system 40 and may be associated in the first absorber 8. Thus by selecting two different dissociation pressures, the system performance may be improved.

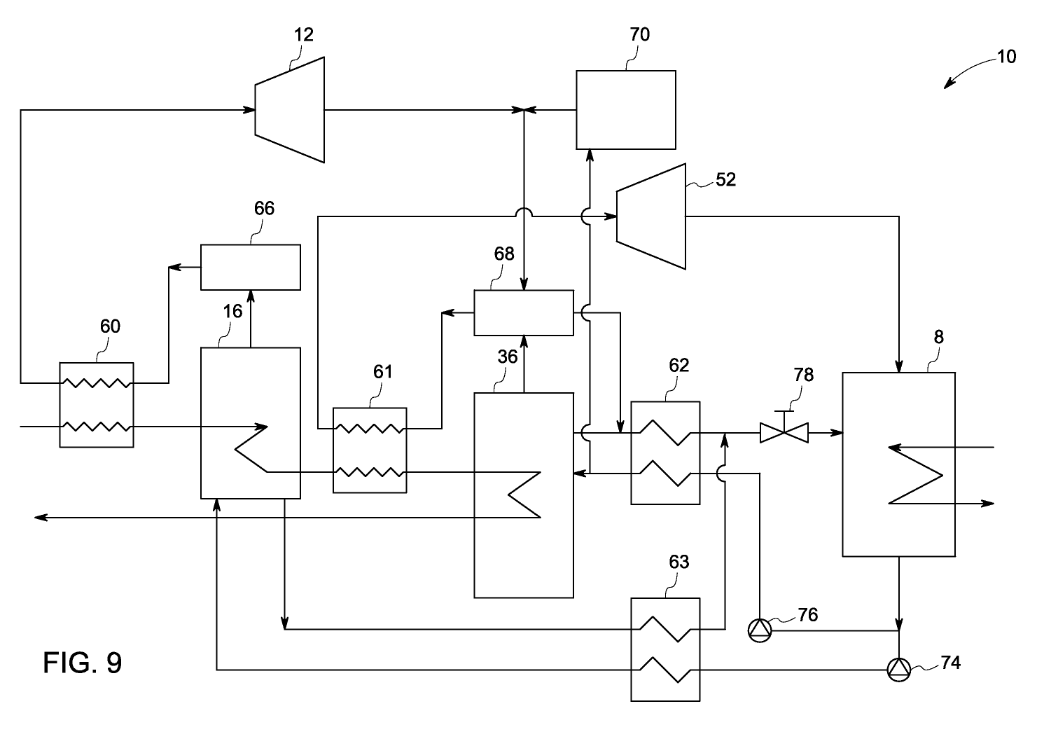

In another embodiment, a system 10 may be used for generating energy in the manner depicted in the FIG. 9. The FIG. 9 depicts the system 10 including a first heat exchanger 16, a second heat exchanger 36, a first superheater 60, a second superheater 61, a first separator 66, a second separator 68, an intercooler 70 which may be a supplementary heat source, first regenerator 62, a second regenerator 63, a first absorber 8, a first energy conversion device 12 and a second energy conversion device 52. In one embodiment, the first superheater 60, the second superheater 61, the first separator 66, the second separator 68, the intercooler 70, the first regenerator 62, and the second regenerator 63 may be present. The system may optionally also have valves and pumps that may be used to control the flow of the various fluids or the associating composition in the system.

In one embodiment, a hot exhaust gas from a reactor such as, for example, an internal combustion engine may be transferred through a first superheater 60, a first heat exchanger 16, a second superheater 61 and a second heat exchanger 36, prior to being exhausted to the atmosphere. The hot exhaust gas may serve as the first fluid. In one embodiment, strontium chloride may be used as the associating composition, while ammonia may serve as the working fluid. Heptanol may function as the carrier fluid. In one embodiment, the heat from the exhaust gas may dissociate the transfer fluid in the first heat exchanger 16 into a working fluid and an associating composition. The heat from the exhaust gas may dissociate another transfer fluid in the heat exchanger 36 into a working fluid and an associating composition. The working fluid from the first heat exchanger 16 may be transferred to a first separator 66 where the working fluid may be further separated from the associating composition and any additional matter that may be contained in the working fluid. The first separator 66 may be located downstream of the first heat exchanger 16 and upstream of the first superheater 60 and may be thermal and/or fluid communication with the first heat exchanger 16 and the first superheater 60. The working fluid may be transferred to the first superheater 60 where it may be further heated. The superheated working fluid from the first superheater 60 may be expanded through a first energy conversion device 12.

In one embodiment, the working fluid upon contacting a moving surface of the first energy conversion device 12 may produce motion in the first energy conversion device 12. This motion may be used to generate electrical energy. The spent working fluid upon exiting the first energy conversion device 12, may be then transferred to a second separator 68, from which it may be transferred to a second superheater 61. The second separator may be located downstream of the first energy conversion device 12 and upstream of a second superheater 61. In another embodiment, the second separator may be located down stream of the second heat exchanger 36 and the intercooler 70 and upstream of a second regenerator 63. In one embodiment, the intercooler 70 may function as a supplementary heat exchanger and may use heat from alternate sources such as heat from a braking system, heat from the exhaust of a chemical reactor, heat from a nuclear reactor, furnaces, gas turbine exhaust, incinerators, annealing furnaces, cement kilns, oxidation processes for ammonia and others, copper reverberatory furnaces, forge and billet-heating furnaces, open-hearth steel furnaces, basic oxygen furnaces, sulfur ore processors, glass melting furnaces, zinc fuming furnaces, or the like. In one embodiment, the second separator 68 may be in thermal and/or fluid communication with the first energy conversion device 12, the second heat exchanger 36, the intercooler 70, and the second superheater 61. The second separator 68 receives spent working fluid from the first energy conversion device 12, the intercooler 70, the second heat exchanger 36 and may separate the working fluid from salt and other unwanted dissolved matter. The separated working fluid may be then transferred to the second superheater 61, where it may be superheated and then expanded through the second energy conversion device 52. Electricity may be generated upon expanding the working fluid through the second energy conversion device 52. In one embodiment, the system may have pumps 74, 76 and valves 78.

In one embodiment, the working fluid may be transferred to the first absorber 8 where it may re-associate with the associating composition from the first heat exchanger 16 and the second heat exchanger 36. In one embodiment, the first absorber 8 may be located downstream of the second heat exchanger 36. The first absorber 8 may receive the spent working fluid from the second heat exchanger and may receive the spent associating composition from the first and second regenerators. During the re-association of the spent working fluid with the spent associating composition from the first and second heat exchangers, heat may be generated as a result of an exotherm that may accompany the association. In one embodiment, a coolant may remove the heat generated in the first absorber 8. The regenerated transfer fluid from the first absorber 8 may then be transferred to a first regenerator 62 and a second regenerator 63 from where it may be transferred to the first heat exchanger 16 and the second heat exchanger 36 respectively thereby completing the cycle. In one embodiment, pumps may be used to pump the regenerated transfer fluid to the first and second regenerators respectively.

In one embodiment, the number of stages in the system 10 of FIG. 9 may be expanded if desired. For example, and additional loop including a third heat exchanger, a third energy conversion device, with additional separators or additional absorbers may be added to the system to improve efficiency.

In one embodiment, the systems and the methods described herein may extract useful energy from waste heat. In one embodiment, the system may be used to improve the efficiency of primary energy systems (such as diesel engines) per unit of power produced or per unit of fuel burned. In addition, the energy generated by utilizing geothermal energy and/or solar energy to generate electricity may minimize environmentally unfriendly emissions into the atmosphere. In another embodiment, the method may be used to absorb heat from the braking systems and the exhaust systems of locomotives, thereby improving fuel efficiency in these locomotives. In another embodiment, the system in that the electrical energy may be used for the generation of hydrogen through electrolysis. In one embodiment, the hydrogen may be further used to generate electricity in a fuel cell. In another embodiment, the exit stream from this method may be used to desalinate salt-water into soft water.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

It is to be noted that as used herein, the terms “first,” “second,” and the like do not denote any order or importance, but rather are used to distinguish one element from another. Furthermore, all ranges disclosed herein are inclusive of the endpoints and independently combinable.

Furthermore, in describing the arrangement of components in embodiments of the present disclosure, the terms “upstream” and “downstream” are used in the specification. These terms have their ordinary meaning. For example, an “upstream” device as used herein refers to a device producing a fluid output stream that is fed to a “downstream” device. Moreover, the “downstream” device is the device receiving the output from the “upstream” device. A device may be built with both “upstream” and “downstream” of the same device in certain configurations, e.g., a system comprising a recycle loop.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for generating energy, comprising:
a first heat exchanger in communication with a first heat source, and the first heat exchanger contacts a transfer fluid that comprises a working fluid and an associating composition; and
a first energy conversion device comprising:
a piston in reciprocatory communication with a cylinder, and
the cylinder comprising an inlet valve or an outlet valve in operative communication with a cam having multiple lobes, and
the cam permitting the expansion or compression of the working fluid in the cylinder two or more times in a single cycle.

2. The system of claim 1, further comprising a first absorber, wherein the first absorber is located downstream of the first energy conversion device, and the first absorber promotes association of the working fluid with the associating composition.

3. The system of claim 2, further comprising a first regenerator in communication with the first heat exchanger, wherein the first regenerator heats a transfer fluid after the fluid exits the first absorber and prior to an entry of the transfer fluid into the first heat exchanger.

4. The system of claim 3, further comprising a first separator in communication with the first heat exchanger and the first energy conversion device, wherein the first separator is located downstream of first heat exchanger, and the first separator separates the working fluid from the associating composition.

5. The system of claim 1, further comprising a first superheater in communication with the first heat exchanger and the first energy conversion device.

6. The system of claim 1, further comprising:
a second heat exchanger and a third heat exchanger in communication with the second heat exchanger; and
a first absorber that is in communication with at least one of the first heat exchanger, the second heat exchanger, or the third heat exchanger, and
the first absorber is in communication with a first energy conversion device and a second energy conversion device.

7. The system of claim 6, further comprising an intercooler; wherein the intercooler is a supplementary heat exchanger that heats a portion of the transfer fluid flowing from the first absorber.

8. The system of claim 7, wherein the intercooler is in communication with the intercooler.

9. The system of claim 1, wherein the first heat exchanger emits vapor, and further comprising a first energy storage unit that receives the vapor from the first heat exchanger.

10. The system of claim 1, wherein the first heat source and the first heat exchanger are part of a closed loop.

11. The system of claim 10, wherein the closed loop comprises a first fluid, and wherein the first fluid contacts a geothermal source of heat located below the earth surface.

12. The system of claim 11, wherein the first fluid comprises an aprotic polar solvent or a protic polar solvent.

13. The system of claim 11, wherein the first fluid comprises a non-polar solvents.

14. The system of claim 1, wherein the first heat exchanger is in communication with a first energy conversion device via a first separator and a first superheater, and wherein the first heat exchanger is upstream of the first separator and the first superheater.

15. The system of claim 14, wherein the first energy conversion device is in communication with an absorber, and wherein the absorber is downstream of the first energy conversion device.

16. The system of claim 15, wherein the first energy conversion device is in communication with an absorber, via a second separator, a second superheater and a second energy conversion device,
wherein the second separator, the second superheater and the second energy conversion device are downstream of the first energy conversion device.

17. The system of claim 16, wherein the absorber is in communication with a first heat exchanger via a regenerator, wherein the regenerator heats the transfer fluid after the transfer fluid exits the absorber.

18. The system of claim 16, wherein the absorber is in communication with a first heat exchanger via a first regenerator and wherein the absorber is in communication with a second heat exchanger via a second regenerator,
wherein the first heat exchanger is down stream of the first regenerator and wherein the second heat exchanger is downstream of the second regenerator,
wherein the regenerator heats the transfer fluid after the transfer fluid exits the absorber.

19. The system of claim 1, wherein the cam has at least two lobes and permits the expansion and compression of the working fluid in the cylinder two or more times in a single cycle.

20. The system of claim 1, wherein the transfer fluid comprises a complex derived from the absorption, adsorption, or chemisorption by the working fluid onto the associating composition.

21. The system of claim 1, wherein the transfer fluid comprises a complex derived from ionic bonding or covalent bonding by the working fluid onto the associating composition.

22. The system of claim 1, wherein the associating composition comprises a salt, and wherein the working fluid comprises a fluid that can undergo a thermally reversible association/dissociation with the salt.

23. The system of claim 1, wherein the associating composition comprises zeolites, clay, or a room temperature ionic liquid.

24. The system of claim 1, wherein the working fluid is ammonia, an alcohol; water; carbon dioxide; hydrogen; an amine; a sebacate; a phthalate; an aldehydes; a formamide; a ketone; acetonitrile; a sulfoxide; a sulfone; an acetate; an amide; or a combination comprising at least two of the foregoing working fluids.

25. A system for generating energy, comprising:
a first heat exchanger in communication with a first heat source, and the first heat exchanger heats a transfer fluid that comprises a working fluid and an associating composition, and the working fluid and the associating composition reversibly associate with each other and heating of the transfer fluid in the first heat exchanger generates a vapor comprising the working fluid;
a first separator in communication with the first heat exchanger and downstream of the first heat exchanger;
a first superheater in communication with the first separator and downstream of the first heat exchanger;
a first energy conversion device comprising a piston in reciprocatory communication with a cylinder; the cylinder comprising an inlet valve or an outlet valve in operative communication with a cam having multiple lobes, and the cam permitting the expansion or compression of the working fluid in the cylinder two or more times in a single cycle;
an absorber downstream of the first energy conversion device and in communication with the energy conversion device, wherein the absorber is adapted to receive the vapor that has passed through the energy conversion device and to receive the associating composition that has passed through the heat exchanger;
a first regenerator located upstream of the absorber and in communication with the absorber, wherein the regenerator receives the transfer fluid from the absorber and allows the transfer fluid to return to the first heat exchanger; and
a pump in communication with the first heat exchanger.

26. A method, comprising:
dissociating a transfer fluid into a working fluid and an associating composition;
vaporizing the working fluid; and
contacting a moving surface of an energy conversion device with the working fluid vapor to effect an energy conversion; the energy conversion device comprising a piston in reciprocatory communication with a cylinder; the cylinder comprising a valve in operative communication with a cam having multiple lobes; the cam permitting the expansion or compression of the working fluid in the cylinder two or more times in a single cycle.

27. The method of claim 26, wherein the dissociating is brought about by heat absorbed in a heat exchanger.

28. The method of claim 26, wherein the dissociating comprises desorption.

29. The method of claim 26, wherein the dissociating comprises breaking of covalent bonds or ionic bonds or hydrogen bonds.

30. The method of claim 26, further comprising associating the vapor of the working fluid with the associating composition in an absorber.

31. The method of claim 26, further comprising associating the vapor of the working fluid with the associating composition in a heat exchanger

32. The method of claim 26, further comprising condensing the vapor of the working fluid into a liquid.
